(19) United States
(12) Patent Application Publication
(10) Pub. No.: US 2014/0325451 A1
(43) Pub. Date: Oct. 30, 2014

(54) ICON CHANGE METHOD AND APPARATUS

(71) Applicant: TENCENT TECHNOLOGY (SHENZHEN) COMPANY LIMITED, Shenzhen (CN)

(72) Inventors: Fei Wang, Shenzhen (CN); Yanjie Wen, Shenzhen (CN); Zhanwei Wang, Shenzhen (CN)

(21) Appl. No.: 14/325,753

(22) Filed: Jul. 8, 2014

Related U.S. Application Data
(63) Continuation of application No. PCT/CN2013/070262, filed on Jan. 9, 2013.

(30) Foreign Application Priority Data
Jan. 13, 2012 (CN) 201210011239.X

(51) Int. Cl. G06F 3/0484; G06F 3/0481

(52) U.S. Cl. CPC G06F 3/04845; G06F 3/04817
USPC 715/838

(57) ABSTRACT

The present invention discloses an icon change method and apparatus, which belong to the field of computer technologies. The icon change method comprises: detecting a user's operation of clicking a preset button, and acquiring a picture; generating a thumbnail of the picture; and changing an icon of the preset button with the thumbnail, The present invention improves the users service experience.

### REFERENCE TO PRIOR APPLICATIONS

This application is a continuation of international application PCT/CN2013/070262 filed Jan. 9, 2013, which claims priority to Chinese Patent Application No. 201210011239.X, filed before Chinese Patent Office on Jan. 13, 2012, and entitled “Icon Change Method and Apparatus”, the contents of each of which are incorporated herein by reference in its entirety.

### TECHNICAL FIELD

The present invention relates to the field of computer technologies, and particularly, to an icon change method and apparatus.

### BACKGROUND

With the development of the wireless Internet technology and the intelligent terminal, more and more users start to use the mobile terminal to access the Internet, and use a browser embedded in the mobile terminal to access webpage, view information or participate in discussions.

In a case where the user edits a text in the communication software using the mobile terminal, if a picture is to be uploaded, the user shall click the upload button in the current webpage to upload the picture. After the picture is successfully uploaded, the thumbnail of the picture is displayed in the text edition area of the current webpage.

In the process of implementing the present invention, the inventor(s) find s) that the prior art at least has the following problem; when a thumbnail of a picture is displayed in the text edition area, the thumbnail of the picture may cover some contents in the text edition area and it occupies the space of the text edition area, thereby directly influencing the user's subsequent text edition operation, and degrading the user's service experience.

### SUMMARY

In order to improve the user's service experience, the embodiments of the present invention provide an icon change method and apparatus. The technical solutions are given as follows.

In one aspect, an icon change method is provided, comprising:

detecting a user's operation of clicking a preset button, and acquiring a picture;

generating a thumbnail of the picture; and

changing an icon of the preset button with the thumbnail.

In another aspect, an icon change apparatus is provided, comprising:

an acquiring module, configured to detect a user's operation of clicking a preset button, and acquire a picture;

a generating module, configured to generate a thumbnail of the picture; and

a changing module, configured to change an icon of the preset button to the thumbnail.

The technical solutions provided by the embodiments of the present invention bring the following beneficial effect: a thumbnail of a picture is generated after the picture is acquired. The is icon of a preset button is changed with the thumbnail, so that the display position of the thumbnail reuses the position of the preset button in the current page. That is, the thumbnail is displayed at the position of the preset button, so that the thumbnail of the picture does not additionally occupy the space of the current page, or influence the user's any edition operation, thereby improving the user's service experience.

### BRIEF DESCRIPTION OF THE DRAWINGS

In order to more clearly describe the technical solutions of the embodiments of the present invention, the drawings to be used in the descriptions of the embodiments will be briefly introduced as follows. Obviously, the following drawings just illustrate some embodiments of the present invention, and a person skilled in the art can obtain other drawings from those drawings without paying any creative effort.

FIG. 1 is a flowchart of an icon change method provided by Embodiment 1 of the present invention;

FIG. 2 is a flowchart of an icon change method provided by Embodiment 2 of the present invention;

FIG. 3 is a schematic diagram of a local picture upload button provided by Embodiment 2 of the present invention;

FIG. 4 is a schematic diagram of a substitutive icon provided by Embodiment 2 of the present invention;

FIG. 5 is a flowchart of an icon change method provided by Embodiment 3 of the present invention;

FIG. 6 is a schematic diagram of a camera button provided by Embodiment 3 of the present invention;

FIG. 7 is a schematic diagram of a substitutive icon provided by Embodiment 3 of the present invention;

FIG. 8 is a first structural schematic diagram of an icon change apparatus provided by Embodiment 4 of the present invention;

FIG. 9 is a second structural schematic diagram of an icon change apparatus provided by Embodiment 4 of the present invention; and

FIG. 10 is a third structural schematic diagram of an icon change apparatus provided by Embodiment 4 of the present invention.

### DETAILED DESCRIPTION

In order that the objective, technical solutions and advantages of the present invention are clearer, the embodiments of the present invention will be further described in details in conjunction with the drawings.

The embodiments of the present invention provide an icon change method and apparatus.

In order that the objective, technical solutions and advantages of the present invention are clearer, the embodiments of the present invention ill be further described in details in conjunction with the drawings.

### Embodiment 1

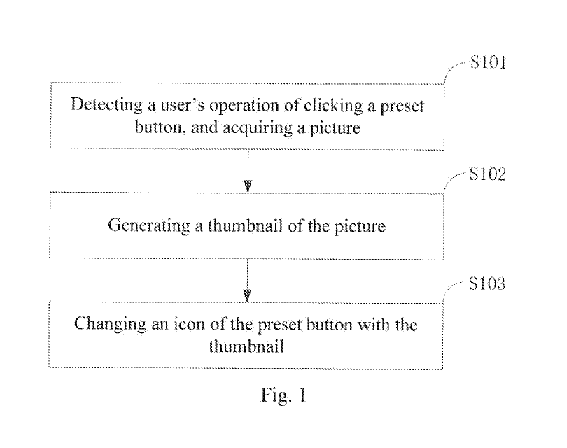

Referring to FIG. 1, which is a flowchart of an icon change method provided by Embodiment 1 of the present invention. in the embodiment, the executive subject may be, but not limited to, a mobile device, and specifically a cell phone.

The icon change method comprises:

S101: detecting a user's operation of clicking a preset button, and acquiring a picture.

The preset button is configured to trigger a picture acquisition. Specifically, the preset button may be, but not limited to, a local picture upload button or a camera button, and any button which can trigger the picture acquisition falls within the protection scope of the present invention.

S102: generating a thumbnail of the picture.

S103: changing an icon of the preset button with the thumbnail.

Optionally, detecting the user's operation of clicking the preset button, and acquiring the picture comprises:

detecting the user's operation of clicking a local picture upload button, and invoking a picture selection interface;

detecting the user's operation of selecting a picture in the picture selection interface, and acquiring the picture selected by the user.

Optionally, changing the icon of the preset button with the thumbnail comprises:

adjusting the size of the thumbnail, so that the size of the thumbnail is consistent with the size of an icon of the local picture upload button;

changing the icon of the local picture upload button with the adjusted thumbnail.

Optionally, detecting the user's operation of clicking the preset button, and acquiring the picture comprises:

detecting the user's operation of clicking a camera button, and invoking a camera interface;

detecting the user's operation of taking a picture in the camera interface, and acquiring the picture taken by the user.

Optionally, changing the icon of the preset button with the thumbnail comprises:

adjusting the size of the thumbnail, so that the size of the thumbnail is consistent with the size of an icon of the camera button;

changing the icon of the camera button with the adjusted thumbnail.

In the embodiment, a thumbnail of a picture is generated after the picture is acquired. The icon of a preset button is changed with the thumbnail, so that the display position of the thumbnail reuses the position of the preset button in the current webpage. That is, the thumbnail is displayed at the position of the preset button, so that the thumbnail of the picture does not additionally occupy the space of the current webpage, or influence the user's any edition operation, thereby improving the user's service experience.

### Embodiment 2

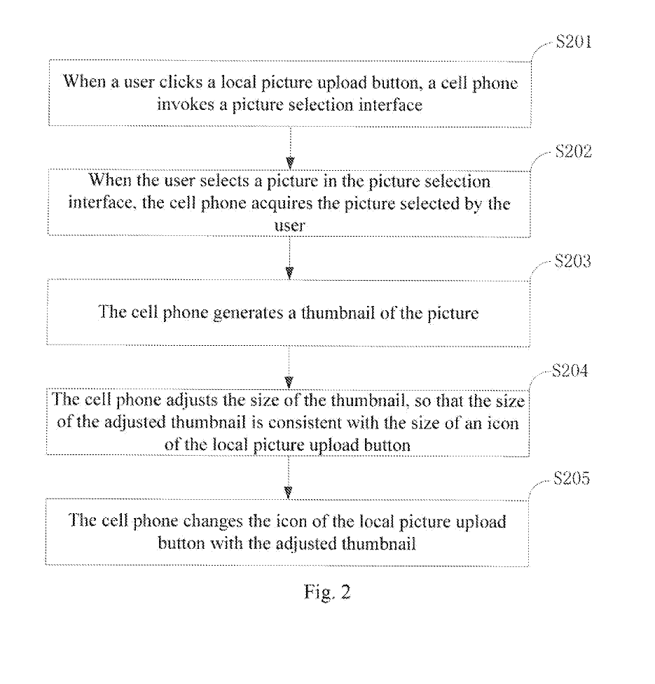

Referring to FIG. 2, which is a flowchart of an icon change method provided by Embodiment 2 of the present invention. In the embodiment, the executive subject may be, but not limited to, a mobile device, and specifically a cell phone. The embodiment is described in details by taking the “Feeling ( [symbol] )” webpage in the Qzone as an example, and herein the preset button is the local picture upload button.

The icon change method comprises:

S201: when the user clicks the local picture upload button, the cell phone invokes a picture selection interface.

In this step, when opening the “Feeling” webpage in the Qzone through a browser of the cell phone, the user can edit a text in the “Feeling” webpage.

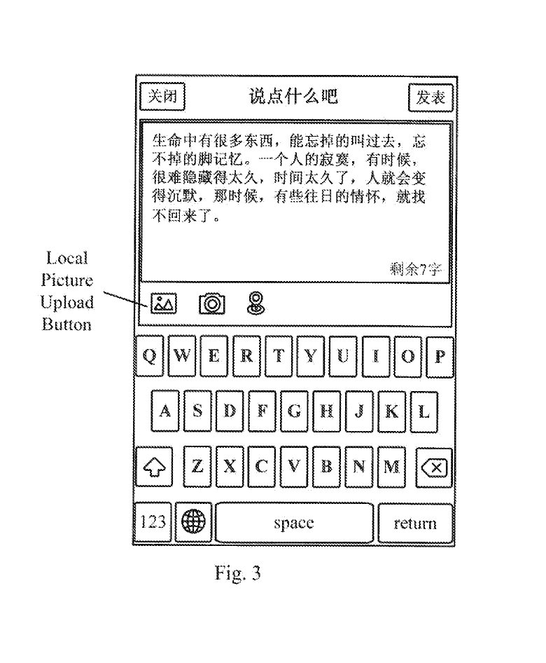

When the user wants to upload a picture, he or she can click the local picture upload button in the “Feeling” webpage. Referring to FIG. 3, which is a schematic diagram of a local picture upload button provided by Embodiment 2 of the present invention. When detecting the user's operation of clicking the local picture upload button, the cell phone invokes the picture selection interface.

In the picture selection interface multiple local pictures are displayed for the user's selection.

S202: when the user selects a picture in the picture selection interface, the cell phone acquires the picture selected by the user.

In this step, the user can select one or more pictures in the picture selection interface. The cell phone detects the user's operation of selecting a picture in the picture selection interface, and acquires the picture selected by the user.

Preferably, the format of the picture selected by the user may be a Portable Network Graphic (PNG) format, a Joint Photographic Experts Group (JPEG) format, or other picture format, which is not limited herein.

S203: the cell phone generates a thumbnail of the picture.

The thumbnail of the picture generated in this step is similar to that in the prior art, and herein is not described.

S204: the cell phone adjusts the size of the thumbnail, so that the size of the adjusted thumbnail is consistent with the size of an icon of the local picture upload button.

In this step, when there is only one thumbnail, the cell phone adaptively adjusts the length and width of the thumbnail, so that the length and width of the thumbnail are consistent with those of the icon of the local picture upload button, thus the thumbnail does not additionally occupy the space of the webpage.

When there is at least one thumbnail, the cell phone adaptively adjusts the at least one thumbnail, so that all the adjusted thumbnails are distributed at the position of the icon of the local picture upload button, i.e., the sizes of the adjusted thumbnails are consistent with that of the icon of the local picture upload button, and the position of each thumbnail is not limited herein. Specifically, when the thumbnails are of an even number, they may equally divide the display space where the icon of the local picture upload button is located.

S205: the cell phone changes the icon of the local picture upload button with the adjusted thumbnail.

In this step, the format of the icon of the local picture upload button may be predefined, and it is consistent with the format of the thumbnail. Preferably, the format of the icon of the local picture upload button may be, but not limited to, a PNG format or a JPEG format.

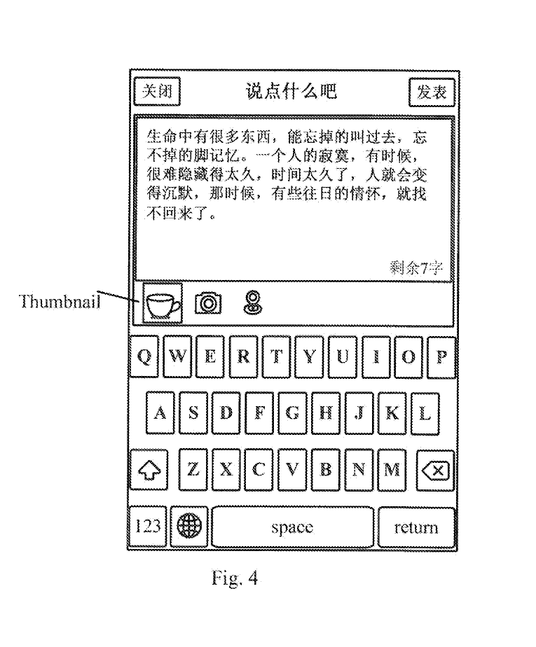

After the size of the thumbnail is adjusted, the icon of the local picture upload button is changed with the adjusted thumbnail. Referring to FIG. 4, which is a schematic diagram of a substitutive icon provided by Embodiment 2 of the present invention, wherein the icon of the local picture upload button is substituted by the thumbnail.

In the embodiment, after the icon of the local picture upload button is substituted for the adjusted thumbnail, the function of the local picture upload button does not change. When a picture is to be changed, the user only needs to click the local picture upload button displayed as the thumbnail, so as to perform steps S201-S205 again to change the picture.

In the embodiment, a thumbnail of a picture is generated after the picture is acquired. The icon of a local picture upload button is changed with the thumbnail, so that the display position of the thumbnail reuses the position of the local picture upload button in the current webpage. That is, the thumbnail is displayed at the position of the local picture upload button, so that the thumbnail of the picture does not additionally occupy the space of the current webpage, or influence the user's any edition operation, thereby improving the user's service experience.

### Embodiment 3

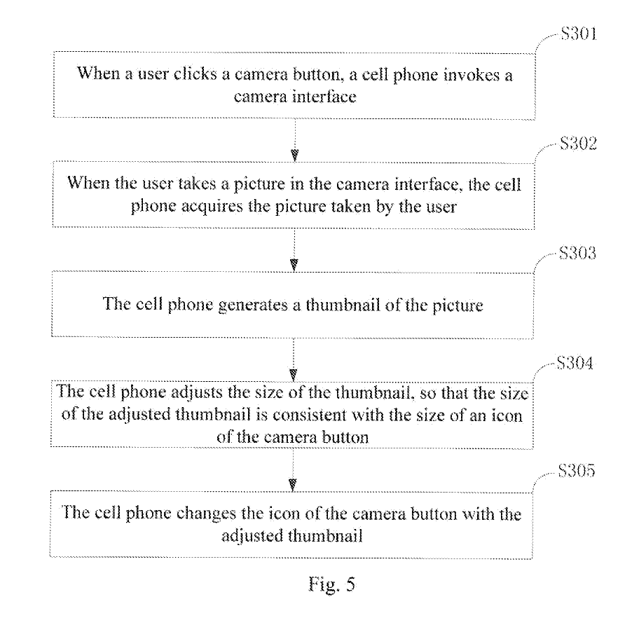

Referring to FIG. 5, which is a flowchart of an icon change method provided by Embodiment 3 of the present invention. In the embodiment, the executive subject may be, but not limited to, a mobile device, and specifically a cell phone. The embodiment is described in details by taking the “Feeling” webpage in the Qzone as an example, and herein the preset button is the camera button.

The icon change method comprises:

S301: when the user clicks the camera button, the cell phone invokes a camera interface.

In this step, when opening the “Feeling” webpage in the Qzone through a browser of the cell phone, the user can edit a text in the “Feeling” webpage.

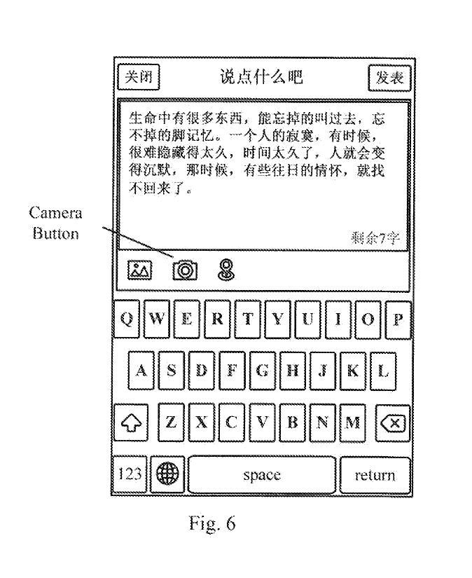

When the user wants to upload a picture, he shall click the camera button in the “Feeling” webpage. Referring to FIG. 6, which is a schematic diagram of a camera button provided by Embodiment 3 of the present invention. When detecting the user's operation of clicking the camera button, the cell phone invokes the camera interface.

S302: when the user takes a picture in the camera interface, the cell phone acquires the picture taken by the user.

In this step, the user can take one or more pictures in the camera interface. The cell phone to detects the user's operation of taking a picture in the camera interface, and acquires the picture taken by the user.

Preferably, the format of the picture taken by the user may be a PNG format, a JPEG format, or other picture format, which is not limited herein.

S303: the cell phone generates a thumbnail of the picture.

The thumbnail of the picture generated m this step is similar to that in the prior art, and herein is not described.

S304: the cell phone adjusts the size of the thumbnail, so that the size of the adjusted thumbnail is consistent with the size of an icon of the camera button.

In this step, when there is only one thumbnail, the cell phone adaptively adjusts the length and width of the thumbnail, so that the length and width of the thumbnail are consistent with those of the icon of the camera button, thus the thumbnail does not additionally occupy the space of the webpage.

When there is at least one thumbnail, the cell phone adaptively adjusts the at least one thumbnail, so that all the adjusted thumbnails are distributed at the position of the icon of the camera button, i.e., the sizes of the adjusted thumbnails are consistent with that of the icon of the camera button, and the position of each thumbnail is not limited herein. Specifically, when the thumbnails are of an even number, they may equally divide the display space where the icon of the camera button is located.

S305: the cell phone changes the icon of the camera button with the adjusted thumbnail.

In this step, the format of the icon of the camera button may be predefined, and it is consistent with the format of the thumbnail. Preferably, the format of the camera button may be, but not limited to, a PNG format or a JPEG format.

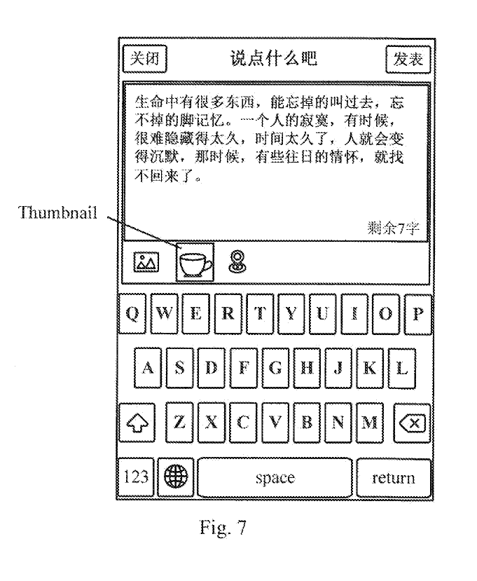

After the size of the thumbnail is adjusted, the icon of the camera button is changed with the adjusted thumbnail. Referring to FIG. 7, which is a schematic diagram of a substitutive icon provided by Embodiment 3 of the present invention.

In the embodiment, after the icon of the camera button is substituted tor the adjusted thumbnail, the function of the camera button does not change. When a picture is to be changed, the user only needs to click the camera button displayed as the thumbnail, so as to perform steps S301-S305 again to change the picture.

In the embodiment, a thumbnail of a picture is generated after the picture is acquired. The icon of a camera button is changed with the thumbnail, so that the display position of the thumbnail reuses the position of the camera button in the current webpage. That is, the thumbnail is displayed at the position of the camera button, so that the thumbnail of the picture does not additionally occupy the space of the current webpage, or influence the user's any edition operation, thereby improving the user's service experience.

### Embodiment 4

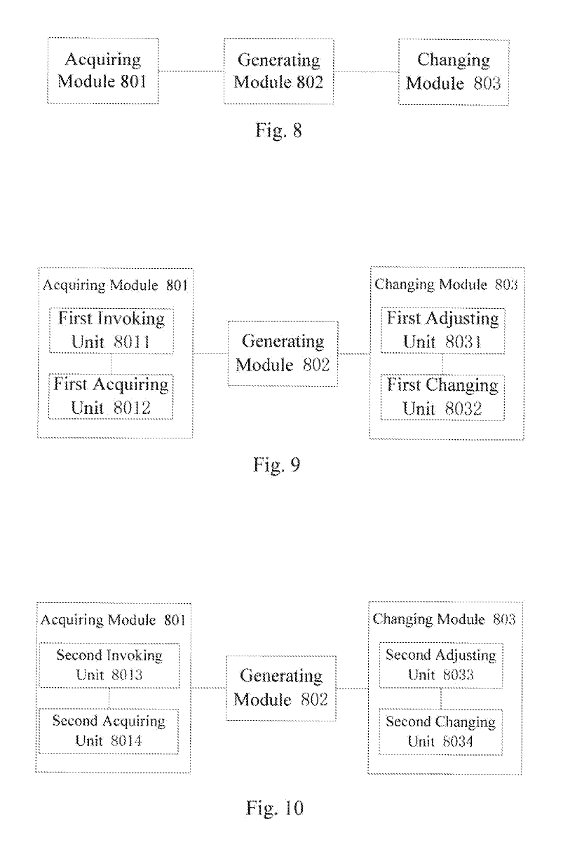

Referring to FIG. 8, which is a first structural schematic diagram of an icon change apparatus provided by Embodiment 4 of the present invention. In the embodiment, the icon change apparatus may be, but not limited to, a mobile device, and specifically a cell phone.

The icon change apparatus comprises:

an acquiring module 801, configured to detect a user's operation of clicking a preset button, and acquire a picture;

a generating module 802, configured to generate a thumbnail of the picture; and

a changing module 803, configured to change an icon of the preset button with the thumbnail.

In which, the acquiring module 801 comprises a first invoking unit 8011 and a first acquiring unit 8012. Referring to FIG. 9, which is a second structural schematic diagram of an icon change apparatus provided by Embodiment 4 of the present invention.

The first invoking unit 8011 is configured to detect the user's operation of clicking a local picture upload button, and invoke a picture selection interface;

The first acquiring unit 8012 is configured to detect the user's operation of selecting a picture in the picture selection interface, and acquire the picture selected by the user.

Further, the changing module 803 comprises:

a first adjusting unit 8031, configured to adjust the size of the thumbnail, so that the size of the thumbnail is consistent with the size of an icon of the local picture upload button; and

a first changing unit 8032, configured to change the icon of the local picture upload button with the adjusted thumbnail.

In another implementation of the embodiment, the acquiring module 801 comprises a second invoking unit 8013 and a second acquiring unit 8014. Referring to FIG. 10, which is a third structural schematic diagram of an icon change apparatus provided by Embodiment 4 of the present invention.

The second invoking unit 8013 is configured to detect the user's operation of clicking a camera button, and invoke a camera interface;

The second acquiring unit 8014 is configured to detect the user's operation of taking a picture in the camera interface, and acquire the picture taken by the user.

Further, the changing module 803 comprises:

a second adjusting unit 8033, configured to adjust the size of the thumbnail, so that the size of the thumbnail is consistent with the size of an icon of the camera button; and

a second changing unit 8034, configured to change the icon of the camera button with the adjusted thumbnail.

In the embodiment, a thumbnail of a picture is generated after the picture is acquired. The icon of a camera button is changed with the thumbnail, so that the display position of the thumbnail reuses the position of the camera button in the current webpage. That is, the thumbnail is displayed at the position of the camera button, so that the thumbnail of the picture does not additionally occupy the space of the current webpage, or influence the user's any edition operation, thereby improving the user's service experience.

To be noted, the embodiments in the Description are described in a progressive manner. Each embodiment lays an emphasis on its distinction from other embodiments, and the same or similar portions of the embodiments may refer to each other. The apparatus embodiment is only briefly described because it is substantially similar to the method embodiment, and for the related portions, please refer to corresponding descriptions of the method embodiment.

To be noted, herein the term “comprise”, “include” or any other variant intends to cover the non-exclusive inclusions, so that a process, a method, an article or a device comprising a series of elements comprise not only those elements, but also other elements not listed clearly, or further comprise inherent elements of such process, method, article or device. In a case where there is no further limitation, the elements defined by a sentence “comprising a . . . ” do not exclude other same elements existing in the process, method, article or device comprising the elements.

A person skilled in the art shall appreciate that all or a part of the steps of the above embodiments may be performed through hardware, or by instructing relevant hardware through a program, and the program may be stored in a computer readable storage medium. The mentioned storage medium may be a Read-Only Memory (ROM), a magnetic disk, an optical disk, etc.

The above descriptions are just preferred embodiments of the present invention, rather than limitations to the present invention. Any amendment, equivalent replacement, improvement, etc. made under the spirit and principle of the present invention shall fall within the protection scope of the present invention.

What is claimed is:

1. An icon change method, comprising:
detecting a user's operation of clicking a preset button, and acquiring a picture;
generating a thumbnail of the picture; and
changing an icon of the preset button with the thumbnail

2. The method according to claim 1, wherein detecting the user's operation of clicking the preset button, and acquiring the picture comprises:
detecting the user's operation of clicking a local picture upload button, and invoking a picture selection interface; and
detecting the user's operation of selecting a picture in the picture selection interface, and acquiring the picture selected by the user.

3. The method according to claim 2, wherein changing the icon of the preset button with the thumbnail comprises:
adjusting the size of the thumbnail, so that the size of the thumbnail is consistent with the size of an icon of the local picture upload button; and
changing the icon of the local picture upload button with the adjusted thumbnail.

4. The method according to claim 1, wherein detecting the user's operation of clicking the preset button, and acquiring the picture comprises:
detecting the user's operation of clicking a camera button, and invoking a camera interface; and
detecting the user's operation of taking a picture in the camera interface, and acquiring the picture taken by the user.

5. The method according to claim 4, wherein changing the icon of the preset button with the thumbnail comprises:
adjusting the size of the thumbnail, so that the size of the thumbnail is consistent with the size of an icon of the camera button; and
changing the icon of the camera button with the adjusted thumbnail.

6. An icon change apparatus, comprising:
an acquiring module configured to detect a user's operation of clicking a preset button, and acquire a picture;
a generating module configured to generate a thumbnail of the picture; and
a changing module configured to change an icon of the preset button with the thumbnail.

7. The apparatus according to claim 6, wherein the acquiring module comprises:
a first invoking unit configured to detect the user's operation of clicking a local picture upload button, and invoke a picture selection interface; and
a first acquiring unit configured to detect the user's operation of selecting a picture in the picture selection interface, and acquire the picture selected by the user.

8. The apparatus according to claim 7, wherein the changing module comprises:
a first adjusting unit configured to adjust the size of the thumbnail, so that the size of the thumbnail is consistent with the size of an icon of the local picture upload button; and
a first changing unit configured to change the icon of the local picture upload button with the adjusted thumbnail.

9. The apparatus according to claim 6, wherein the acquiring module comprises:
a second invoking unit configured to detect the user's operation of clicking a camera button, and invoke a camera interface; and
a second acquiring unit configured to detect the user's operation of taking a picture in the camera interface, and acquire the picture taken by the user.

10. The apparatus according to claim 9, wherein the changing module comprises:
a second adjusting unit configured to adjust the size of the thumbnail, so that the size of the thumbnail is consistent with the size of an icon of the camera button; and
a second changing unit configured to change the icon of the camera button with the adjusted thumbnail.
